(19) United States
(12) Patent Application Publication
(10) Pub. No.: US 2025/0251488 A1
(43) Pub. Date: Aug. 7, 2025

(54) Precoding Design for Integrated Sensing and Communication Systems

(71) Applicant: Samsung Electronics Company, Ltd., SUWON SI (KR)

(72) Inventors: Rui Huang, Vancouver (CA); Sanjeewa Herath, Ottawa (CA)

(21) Appl. No.: 18/435,834

(22) Filed: Feb. 7, 2024

(51) Int. Cl. G01S 7/02; G01S 7/00; G01S 13/86; H04L 5/00

(52) U.S. Cl. CPC G01S 7/0234; G01S 7/006; G01S 13/86; H04L 5/0051

(57) ABSTRACT

In one embodiment, a method includes determining sensing requirements for a sensing functionality associated with a first electronic device based on first signals from one or more second electronic devices, determining channel state information for a communication functionality associated with the first electronic device based on second signals from one or more of the second electronic devices, generating codebooks based on one or more of the sensing requirements or the channel state information, determining a sensing precoder and a communication precoder based on one or more of the codebooks, transmitting a sensing signal and a communication signal from the first electronic device, wherein the sensing signal is generated based on the sensing precoder and the communication signal is generated based on the communication precoder.

### TECHNICAL FIELD

This disclosure relates generally to integrated sensing and communication (ISAC) systems, and in particular relates to dual functioning of sensing and communication in ISAC systems.

### BACKGROUND

With the deployment of the millimeter wave and massive multiple-input multiple-output (MIMO) technologies, the communication signals in beyond 5G/6G wireless systems may be able to have high-resolution in both time and angular domain, making it possible to enable high-accuracy sensing using the communication signals. As such, it is desirable to jointly design the sensing and communication systems such that they can share the same frequency band and hardware to improve the spectrum efficiency and reduce the hardware cost. This motivates the design of integrated sensing and communication (ISAC) systems.

Compared to the existing communication systems, the future ISAC systems need to provide satisfactory performances in both sensing and communication. To achieve such dual functioning by sharing the same set of hardware and same time/frequency resources, various designs of the existing communication systems need to be revisited and enhanced.

Due to the resources sharing (such as time, frequency, and power) between sensing and communication, one issue in the ISAC systems is how to balance the trade-off between sensing and communication. Consider a sensing-centric application, it is desirable to prioritize the sensing requirement (e.g., achieving a 3-D localization accuracy of less than 1 meter), and using all of the remaining resources to provide the best data transmission services to the users as possible.

### BRIEF DESCRIPTION OF THE DRAWINGS

FIG. 1 illustrates an example flow diagram for determining the precoders.

FIGS. 2A-2B illustrate example signaling for communicating sensing requirement.

FIG. 3 illustrates an example block diagram for explicit signaling-based precoder design.

FIG. 4 illustrates an example block diagram for PMI-based precoder design.

FIG. 5 illustrates an example sequence diagram for a scenario where a device acts as both type II and type III nodes.

FIG. 6 illustrates an example sequence diagram for a scenario where type II and type III nodes are different devices.

FIG. 7 illustrates an example sequence diagram for a scenario where type III nodes report the optimal precoder for joint sensing and communication.

FIG. 8 illustrates example best codebooks for communication only and joint sensing and communication, respectively.

FIG. 9 illustrates example effects of using a different sensing angle on the radar distortion and achievable throughput.

FIG. 10 illustrates an example radar distortion and achievable throughput experienced by another user equipment with the same sensing angle.

FIG. 11 illustrates is a flow diagram of a method for determining sensing and communication precoders, in accordance with the presently disclosed embodiments.

FIG. 12 illustrates an example computer system that may be utilized for determining sensing and communication precoders, in accordance with the presently disclosed embodiments.

### DESCRIPTION OF EXAMPLE EMBODIMENTS

### Spectrum Controlled Waveform Multiplexing

In particular embodiments, an ISAC system may achieve target sensing and communication requirements by processing signals for sensing and/or communication at antenna arrays at network devices, based on either implicit or explicit signaling from the network devices. Based on the target sensing requirement, implicit and/or explicit signaling, the ISAC system may implement precoding steps to guarantee the desired sensing requirement and meanwhile providing satisfactory data transmission services to the network devices. To achieve dual-function sensing and communication by sharing the same set of hardware and resources, the ISAC system may determine the requirements related to the sensing service based on the signaling from the network devices. In particular embodiments, the ISAC system may exchange and communicate the sensing requirements by using one or more of uplink signaling, downlink signaling, or control signaling. Indicating such sensing requirements may be necessary for subsequent multi-antenna processing and precoding. In particular embodiments, the ISAC system may determine the optimal precoders (i.e., how the signals for sensing and communication should be processed at the antenna arrays) based on the explicit signaling between multiple network devices. The ISAC system may utilize the explicit information about the sensing and communication environment obtained based on explicit signaling to determine the optimal precoders to achieve the target sensing and communication performance. In particular embodiments, the ISAC system may determine the optimal precoders based on the implicit signaling between multiple network devices. Compared with explicit signaling, the implicit signaling may have a smaller signal overhead but meanwhile offering less and indirect information about the sensing and communication environment. The ISAC system may modify and update the precoder design based on the implicit signaling. Although this disclosure describes particular precoding by particular systems in a particular manner, this disclosure contemplates any suitable precoding by any suitable system in any suitable manner.

In particular embodiments, a first electronic device may determine, based on one or more first signals from one or more second electronic devices, one or more sensing requirements for a sensing functionality associated with the first electronic device. The first electronic device may then determine, based on one or more second signals from one or more of the second electronic devices, channel state information for a communication functionality associated with the first electronic device. In particular embodiments, the first electronic device may generate, based on one or more of the sensing requirements or the channel state information, one or more codebooks. The first electronic device may then determine, based on one or more of the codebooks, a sensing precoder and a communication precoder. The first electronic device may further transmit, a sensing signal and a communication signal from the first electronic device. In particular embodiments, the sensing signal may be generated based on the sensing precoder and the communication signal may be generated based on the communication precoder.

Certain technical challenges exist for determining sensing and communication precoders. One technical challenge may include efficiently transmitting sensing requirements. The solution presented by the embodiments disclosed herein to address this challenge may be quantizing the sensing requirements as the indices of the sensing parameters may be transmitted instead of actual values, which may be more efficient to transmit via different types of signaling. Another technical challenge may include determining optimal precoders via implicit signals. The solution presented by the embodiments disclosed herein to address this challenge may be estimating channel information about the actual channel as the channel estimation may capture the potential interference between sensing and communication signals, which enables determining the actual achievable data rate for a particular pair of sensing and communication precoders.

Certain embodiments disclosed herein may provide one or more technical advantages. A technical advantage of the embodiments may include supporting simultaneous sensing and communication which is a highly desirable functionality of future cellular systems such as 5G-Advanced, 6G, and Wi-Fi systems. Another technical advantage of the embodiments may include improved multi-antenna processing for communication and sensing signals based on either explicit or implicit signaling as such signaling may provide useful information for determining optimal precoders for both communication and sensing tasks. Certain embodiments disclosed herein may provide none, some, or all of the above technical advantages. One or more other technical advantages may be readily apparent to one skilled in the art in view of the figures, descriptions, and claims of the present disclosure.

Precoding is a technology that determines how the signals should be transmitted at the antenna array. Precoding may be an important factor to achieve robust sensing and communication performance in ISAC systems. For communication purpose, a proper precoding scheme may mitigate the interference between multiple users and data streams, thereby increasing the data transmission rate. Moreover, for sensing purpose, the precoding scheme may determine the beam pattern (e.g., the direction and the width of the wireless beam), which may be directly related to the sensing accuracy that can be achieved based on the transmitted signals.

In particular embodiments, the ISAC system disclosed herein may determine precoding based on explicit and/or implicit signaling from and between network devices, including gNB (a node in a cellular network) and user equipment. Moreover, the ISAC system may use uplink and downlink signaling for communicating the sensing requirements. With the precoding disclosed herein, the sensing and communication signals may be processed properly at the antenna array accordingly to achieve the desirable sensing and communication requirements. As a result, the embodiments disclosed herein may have a technical advantage of supporting simultaneous sensing and communication which is a highly desirable functionality of future cellular systems such as 5G-Advanced, 6G, and Wi-Fi systems.

The present disclosure uses sounding reference signal (SRS) as an example to illustrate the precoding based on explicit signaling. The present disclosure uses precoding matrix indicator (PMI) reports as an example to illustrate the precoding based on implicit signaling. Moreover, the present disclosure uses scheduling request (SR) as an example to illustrate the signaling design for communicating the sensing requirement. However, the embodiments disclosed herein can also be applied to other explicit and implicit signaling, such as other reference signals including channel state information reference signal (CSI-RS), SRS, demodulation reference signal (DMRS), or any suitable reference signal. In addition, although low-band time division duplexing (TDD) systems are exemplified for illustrating the motivation, the embodiments disclosed herein can be applied to any frequency band in FR1 and/or FR2 and/or frequency division duplexing (FDD) systems.

In particular embodiments, the precoders disclosed herein may achieve the target sensing requirement, and meanwhile providing satisfactory data transmission rate to deliver data packages. The disclosed ISAC system may include a plurality of types of nodes (or network devices) with the following definitions and functionalities. Type I nodes may include the nodes or network devices that transmit the sensing and communication signals. Type II nodes may include the nodes or network devices that receive the communication signals. Type III nodes may include the nodes or network devices that receive the sensing signals.

In particular embodiments, a particular device may perform more than one or multiple functions or act as more than one types of the nodes. As an example and not by way of limitation, in a mono-static ISAC system, a gNB that transmits and receives the sensing and communication signals may act as both type I and type III nodes; and a user equipment may act as a type II node. As another example and not by way of limitation, in a bi-static ISAC system, one gNB that transmits the sensing and communication signals may act as a type I node; another gNB that receives the sensing and communication signals may act as a type III node; and a user equipment may act as a type II node. As yet another example and not by way of limitation, in a bi-static ISAC system, one gNB that transmits the sensing and communication signals may act as a type I node; a user equipment that receives the sensing and communication signals may act as a type III node; and another user equipment may act as a type II node. As yet another example and not by way of limitation, in a bi-static ISAC system, one user equipment that transmits the sensing and communication signals may act as a type I node; and a gNB that receives the sensing and communication signals may act as Type II and III nodes. Similarly, other configurations/setups may be feasible.

The present disclosure refers to the transmission and receiving of the communication signals between a pair of type I and type II nodes as a communication link. Similarly, the present disclosure refers to the transmission and receiving of the sensing signals between a pair of type I and type III nodes as a sensing link.

In the following, the present disclosure uses a downlink multi-user MIMO (MU-MIMO) system as an example to illustrate the problem of precoder design. In this example, the embodiments disclosed herein consider a mono-static sensing scenario, where a single gNB is transmitting and also receiving the sensing signals. That is, this single gNB is acting as both type I and type III nodes. In the example system, there may be multiple communication links due to the presence of multiple communication users.

In particular embodiments, the one or more sensing requirements may be determined based on a radar waveform distortion on a desired sensing direction. For sensing requirement, as an example and not by way of limitation, the embodiments disclosed herein consider a desired sensing direction which is given as θ. Accordingly, the sensing requirement may be that the maximum radar waveform distortion on the sensing direction θ should be less than or equal to Δ. That is,

$${\vert Φ ( θ ) - {a}_{R}^{H} ( θ ) R {a}_{R} ( θ ) \vert}^{2} \leq Δ , \qquad ( 1 )$$

where ϕ(θ) is the desired radar waveform on direction θ, α_{R}(⋅) is the beam steering vector of the transmit antenna panel, and R is the radar cross-section (RCS) matrix that can be determined by the sensing precoder f_{R} as R=f_{R}f_{R}^{H}. In this example, the embodiments disclosed herein consider one sensing direction, i.e., one sensing link. However, the embodiments disclosed herein may be applied to systems with multiple sensing links.

For data communication, let matrix H denote the downlink channel for data communication between gNB and user equipment. Let s_{R} and s_{c,k} denote the signal for sensing and the modulated symbols for the communication of user n, respectively. Let f_{c,k} denote the precoder for the communication symbols of user k.

When s_{R} and s_{c,k} are uncorrelated, e.g., when different waveforms are used for sensing and communication, the signal-to-interference-plus-noise ratio (SINR) at user-equipment (UE) k may be given by:

$${γ}_{k} ∝ \frac{{‖ {w}_{k}^{H} {Hf}_{C , k} ‖}^{2}}{{‖ {\sum }_{j \neq n} {w}_{k}^{H} H {f}_{C , j} ‖}^{2} + {‖ {w}_{k}^{H} {Hf}_{R} ‖}^{2} + {‖ {w}_{k} ‖}_{2}^{2} {σ}^{2}} , \qquad ( 2 )$$

where wₖ is the combiner at UE k, which may be determined by mean square error (MMSE) combiner, and σ² is the noise power.

When s_{R} and s_{c,k} are correlated, e.g., when the same waveform is used for sensing and communication, the signal-to-interference-plus-noise ratio (SINR) at UE k may be given by:

$${γ}_{k} ∝ \frac{{‖ {w}_{k}^{H} {Hf}_{C , k} ‖}^{2}}{{‖ {w}_{k} ‖}_{2}^{2} {σ}^{2}} . \qquad ( 3 )$$

In particular embodiments, the precoder design problem in such downlink MU-MIMO system may be formulated as:

$${max}_{{f}_{C , k} , {f}_{R}} g ( {γ}_{1} , {γ}_{2} , … , {γ}_{k} ) \qquad ( 4 )$$

$$subject to$$

$$C 1 : {\vert Φ ( θ ) - {a}_{R}^{H} ( θ ) R {a}_{R} ( θ ) \vert}^{2} \leq Δ ,$$

$$C 2 : {‖ {f}_{C , k} ‖}_{2}^{2} + {‖ {f}_{R} ‖}_{2}^{2} \leq {P}^{max} ,$$

where the objective function g(γ₁, γ₂, . . . , γₖ) is determined based on the SINRs of all communication user equipment, while satisfying the sensing requirement given by constraint C1. Constraint C2 is the maximum transmit power constraint. The objective function g(γ₁, γ₂, . . . , γₙ) may be chosen based on the communication requirements. The following includes some examples of g(γ₁, γ₂, . . . , γₖ). One example may be the downlink sum rate of the communication user equipment, e.g., Σk log(1+γₖ). Another example may be the minimum downlink rate achieved by the user equipment, e.g.,

$${min}_{k} log ( 1 + {γ}_{k} ) .$$

Another example may be UE fairness, which may be represented as a weighted sum rate of the communication user equipment, e.g., Σₖβₖ log(1+γₖ), where βₖ≥0 is the weight assigned to UE k in order to achieve fairness.

Note that while the embodiments disclosed herein use the above problem formulated for MU-MIMO system as an example, the embodiments disclosed herein may be applied to systems with more than one gNB and systems with different formats of the sensing requirements.

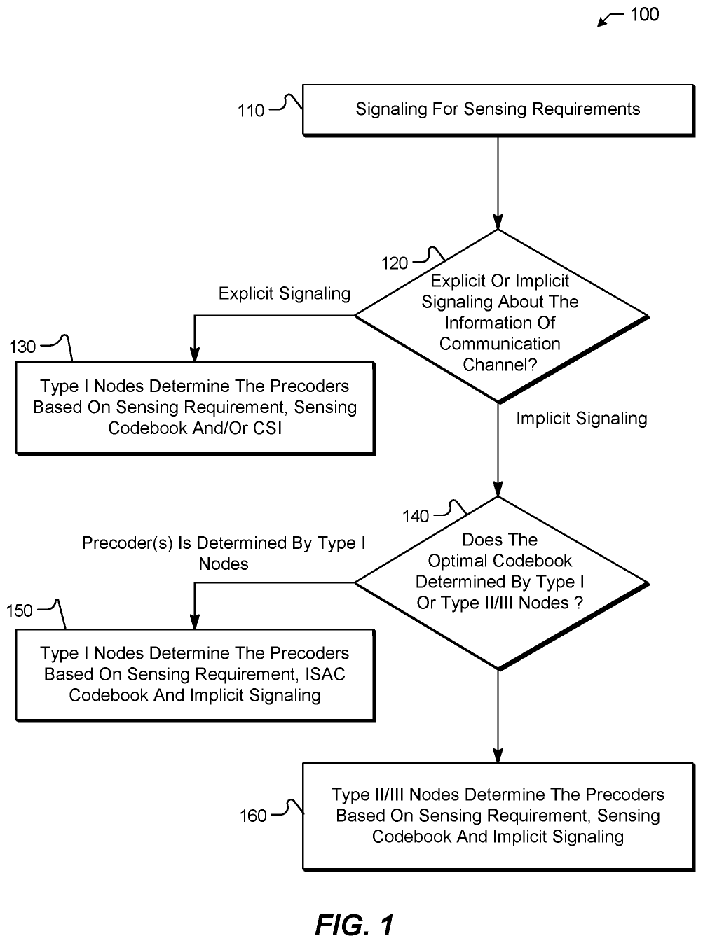

FIG. 1 illustrates an example flow diagram 100 for determining the precoders. In particular embodiments, the first electronic device may receive, at the first electronic device from the one or more second electronic devices, the one or more first signals via one or more of an uplink signaling, a downlink signaling, or a control signaling. At step 110, the ISAC system may obtain the sensing requirements based on uplink, downlink, or control signaling. Before determining the precoders for sensing and communication signals, it may be necessary for the network devices to communicate about the sensing requirements. In particular embodiments, the one or more sensing requirements may comprise one or more of a metric informing a sensing direction, a metric informing a sensing location, a metric informing a sensing area, or a metric informing a desired sensing accuracy.

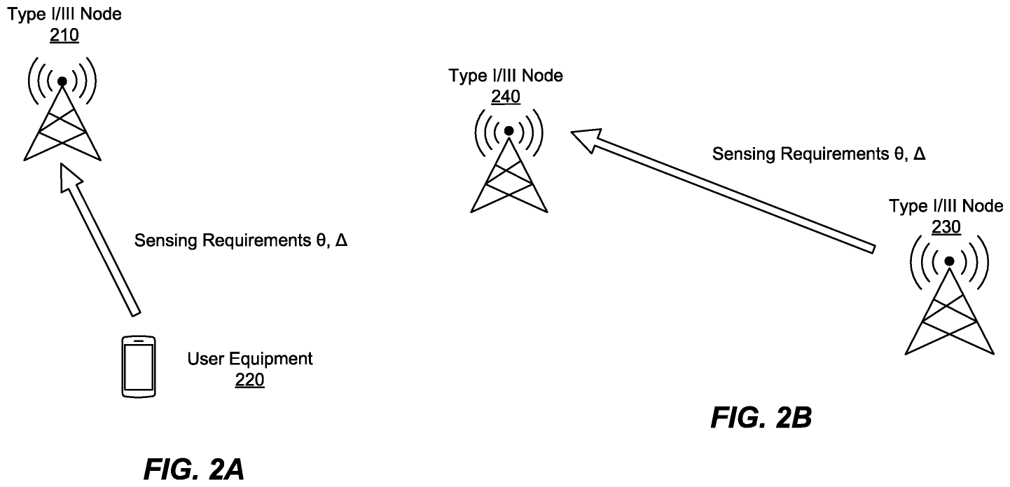

FIGS. 2A-2B illustrate example signaling for communicating sensing requirement. As an example and not by way of limitation, in FIG. 2A, a gNB 210 may act as type I and type III nodes. A user equipment 220 may request the sensing functionality from the gNB 210, and this user equipment 220 may need to send an uplink signal to inform the gNB 210 about the sensing requirement θ (e.g., metrics to inform the direction, location, or area of the sensing) and Δ (e.g., metrics to inform the desired quality/accuracy). As another example and not by way of limitation, in bi-static and multi-static sensing, multiple gNBs may collaborate for sensing objectives. As illustrated in FIG. 2B, one gNB 230 may need to share the sensing requirement θ and Δ with the other gNB 240 (could be more other gNBs) to accomplish multi-static sensing.

To communicate the sensing requirements, particular embodiments may quantize each parameter in the sensing requirements into a finite number of values. In particular embodiments, the sensing direction θ and maximum radar distortion Δ may be quantized into M and N different values, respectively. That is, θ∈{θ₁, θ₂, . . . , θ_{M}} and Δ∈{Δ₁, Δ₂, . . . , Δ_{N}}. In particular embodiments, one or more metrics/parameters that are representative of sensing requirement such as sensing direction, location, area, range or velocity resolution, confidence level, range or velocity resolution, horizontal and vertical position, refreshing rate, missed-detection, false-alarm, or maximum service latency, may be quantized and/or informed. The number of quantized values may be chosen differently for different sensing parameters.

Then, the sensing requirements θ and Δ may be quantized to the closest values as θₘ∈{θ₁, θ₂, . . . , θ_{M}} and Δₙ∈{Δ₁, Δ₂, . . . , Δ_{N}}, respectively. Here, θₘ is the m-th value in {θ₁, θ₂, . . . , θ_{M}} and Δₙ is the n-th value in {Δ₁, Δ₂, . . . , Δ_{N}}.

With the quantized sensing parameters, it may be sufficient to send the indices of the parameters, i.e., (m,n), instead of that actual values of sensing parameters using uplink, downlink, or control signaling such as downlink control information (DCI), uplink control information (UCI), MAC control element (MAC-CE), or radio resource control (RRC). In one embodiment, user equipment may use the scheduling request (SR) and buffer status reports (BSRs) to inform the gNB of the sensing requirements. Table 1 illustrates the control elements in one (short) BSR.

TABLE 1
Control elements in a BSR.

| | | |
|---|---|---|
| LCG ID | Buffer Size #1 | Buffer Size #2 |

As an example and not by way of limitation, for using the above BSR to send sensing requirement, the gNB may assign and reserve a unique logical channel group (LCG) identifier (ID) for the use of signaling sensing requirement. Such unique LCG ID may be different from those assigned for the use of regular data communication. Then, each field of the buffer size, i.e., Buffer Size #1 and #2, may be used to carry the index of one sensing parameters. Since the bit-field size for each buffer size is 6, each buffer size may represent a number from 0 to 63. That is, using the buffer size field in the BSR may support up to 64 quantized values of each sensing parameters. For example, assuming the sensing direct θ is always between 0 and 360, the ISAC system may quantize θ into 64 possible values illustrated in Table 2, with one index assign to each of them.

TABLE 2
An example for the quantization of sensing parameter θ.

| Index m | Corresponding quantized value of θₘ |
|---|---|
| m = 1 | θ₁ = 0 |
| m = 2 | θ₂ = 5.625 |
| . . . | . . . |
| m = 64 | θ₆₄ = 360 |

One example of BSR for sending sensing requirements θ and Δ is illustrated in Table 3.

TABLE 3
One example BSR for sending sensing requirements.

| | | |
|---|---|---|
| LCG ID = 0 | Buffer Size #1 = 53 | Buffer Size #2 = 36 |

With LCG ID=0, it may indicate that this BSR is used for sending sensing requirements, instead of regular buffer report. The value encoded in buffer size #1 may indicate the index of the first sensing parameter θ, which corresponds to θ₅₃. The value encoded in buffer size #2 may indicate the index of the second sensing parameter Δ, which corresponds to Δ₃₆. Given the quantization of sensing parameters, the receiver of this BSR ma obtain the sensing requirements. Quantizing the sensing requirements may be an effective solution for addressing the technical challenge of efficiently transmitting sensing requirements as the indices of the sensing parameters may be transmitted instead of actual values, which may be more efficient to transmit via different types of signaling.

Note that while the present disclosure used BSR as an example, the embodiments disclosed herein may be applied to other uplink, downlink, or control signaling that is capable of sending the indices of the sensing parameters, such as sounding reference signal. The embodiments disclosed herein may also be applied regardless of whether the user equipment that request sensing are in RRC-connected, RRC-idle, RRC-inactive or any other RRC state. Signaling or sending the requirements and parameters for sensing may also be done by one or more RRC state transition command/signaling messages such as RRC release, resume, establish message.

Referring back to FIG. 1, at step 120, the ISAC system may determine whether explicit or implicit signaling about the information of communication channel is available.

In particular embodiments, the one or more second signals may comprise one or more of a sounding reference signal (SRS), a reference signal, or a pilot signal. The gNB may be capable of obtaining the explicit signaling regarding the channel state information (CSI), e.g., through the sounding reference signal (SRS). At step 130, type I nodes may determine the precoders based on sensing requirements, sensing codebook, and/or CSI.

In the following, the present disclosure uses SRS as an example to illustrate how to determine precoders based on explicit signaling. However, it should be noted that embodiments disclosed herein may also be applied to other types of explicit signals, such as reference signals and pilot signals.

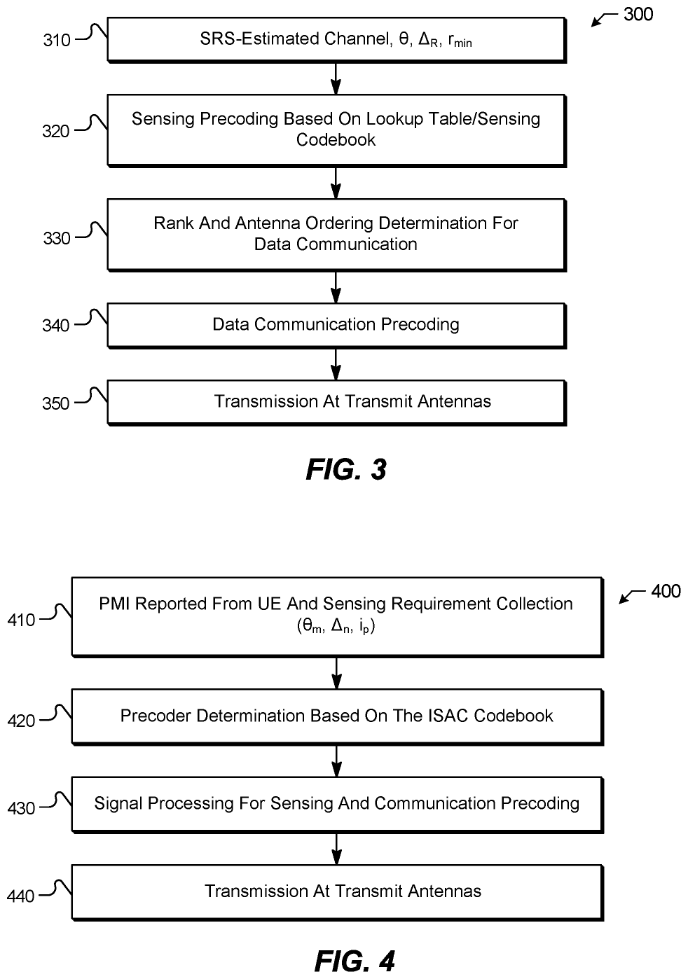

FIG. 3 illustrates an example block diagram 300 for explicit signaling-based precoder design. In particular embodiments, the one or more second signals may comprise one or more explicit signals. At step 310, the ISAC system may determine SRS-estimated channel. In the following, the present disclosure uses the example where the symbols s_{c,k} for downlink communication and sensing symbols s_{R} are uncorrelated. The ISAC system may first determine the sensing precoder f_{R} for sensing symbol s_{R}. With given quantized sensing requirements (θₘ, Δₙ), in one example embodiment, the sensing precoder to achieve these requirements, denoted as f_{R}(θₘ, Δₙ), may be determined by solving the following problems:

$$P 1 : min \vert Φ ( {θ}_{m} ) - {a}_{R}^{H} ( {θ}_{m} ) {Ra}_{R} ( {θ}_{m} ) {\vert}^{2} . \qquad ( 5 )$$

$$s . t . C 1 : R \geq 0 , C 2 : diag ( R ) \leq 1$$

$$P 2 : find {α}_{R} \qquad ( 6 )$$

$$s . t . {\vert Φ ( {θ}_{m} ) - {α}_{R} {a}_{R}^{H} ( {θ}_{m} ) {Ra}_{R} ( {θ}_{m} ) \vert}^{2} \leq {Δ}_{n}$$

The above problems may be solved using various optimization tools, such as convex optimizations and other numerical methods. The particular tools for solving these problems may be chosen based on the implementation setups, such as hardware capabilities.

In particular embodiments, the one or more codebooks may comprise one or more sensing codebooks. After solving the above problems for each possible combination of (θₘ, Δₙ) (M×N combinations in total), the sensing codebook may be obtained. Table 4 illustrates an example sensing codebook.

TABLE 4
An example sensing codebook.

| | Maximum Radar | | Maximum Radar |
|---|---|---|---|
| | distortion Δ₁ | . . . | distortion Δ_{N} |
| Sensing direction θ₁ | f_{R}(θ₁, Δ₁) | . . . | f_{R}(θ₁, Δ_{N}) |
| . . . | . . . | . . . | . . . |
| Sensing direction θ_{M} | f_{R}(θ_{M}, Δ₁) | . . . | f_{R}(θ_{M}, Δ_{N}) |

In particular embodiments, the sensing precoder may be determined further based on the one or more sensing requirements and the one or more sensing codebooks. At step 320, the ISAC system may determine sensing precoding based on the sensing codebook. The sensing codebook in Table 4 may establish a mapping between an arbitrary sensing requirement setting (θₘ, Δₙ) to the corresponding sensing precoder f_{R}(θₘ, Δₙ) that can achieve such requirements. In particular embodiments, type I nodes and/or type II nodes and/or type III nodes may maintain the sensing codebook, such that the sensing precoder f_{R}(θₘ, Δₙ) can be determined directly by looking for the entry in the sensing codebook corresponding to the sensing requirements. By doing so, the network devices may skip the intensive computations and reduce the delay caused by such computations. These advantages may make the embodiments disclosed herein easy and suitable for the implementations in practical systems.

In particular embodiments, more than one sensing precoder may be chosen from the codebook. As an example and not by way of limitation, several sensing precoders that meet the communication requirement may be chosen and/or reported. As another example and not by way of limitation, several precoders corresponding to the neighboring metrics may be chosen and/or reported. Considering that sensing direction from the requirement is θ, the precoders that meet the requirements for sensing direction range θ+δ to θ−δ may be chosen and/or reported.

In particular embodiments, the communication precoder may be determined further based on the sensing precoder. With the chosen sensing precoder f_{R}(θₘ, Δₙ), the communication precoder f_{c,k} may be determined based on whether the communication and sensing symbols are correlated. When the communication symbols s_{c,k} and sensing symbols s_{R} are uncorrelated, the precoded sensing symbols Hf_{R}s_{R} may be treated as the interference towards the communication symbols, which may be suppressed by the communication precoder f_{c,k}. In one embodiment, the following modified version of the semi-orthogonality user scheduling (mSUS) algorithm may be applied to determine f_{c}. The present disclosure denotes the interreference incurred by the sensing signal on each subchannel as v=[h₁^{H}f_{R}s^{R}, . . . , h_{N}_{_{R}}f_{R}s_{R}], where N_{R} is the number of antennas at the receiver of communication signals. Let b_{n,i} denote the beamforming loss for the n-th subchannel on the i-th layer of data communication. Due to the additional interference from the sensing signal, in the disclosed mSUS algorithm, this beamforming loss may be derived as b_{n,i}=b_{n,i}*g(|hₙ^{H}f_{R}s_{R}|), where g(⋅) is a function that decreases monotonically with respect to the power of the interreference from sensing signal, i.e., |hₙ^{H}f_{R}s_{R}|. As an example and not by way of limitation,

$$g ( \vert {h}_{n}^{H} {f}_{R} {s}_{R} \vert ) = \frac{1}{1 + \frac{\vert {h}_{n}^{H} {f}_{R} {s}_{R} \vert}{{σ}^{2}}} .$$

With the modified beamforming loss, the communication precoder f_{c,k} may be determined by following the remainder of the original SUS algorithm, with the zero-forcing algorithm to cancel the interference. At this point, both the sensing precoder f_{R}(θₘ, Δₙ) and the communication precoder f_{c,k} have been determined.

At step 330, the ISAC system may rank and determine antenna ordering for data communication. At step 340, the ISAC system may perform data communication precoding. At step 350, the ISAC system may perform transmission at transmit antennas.

In particular embodiments, the gNB may only obtain information about CSI via implicit signals. These implicit signals may not directly provide the exact value of each entry in the CSI matrix, but they may reflect on the properties of the CSI matrix which could be beneficial to the precoder design.

Referring back to FIG. 1, at step 140, the ISAC system may determine whether the optimal codebook is determined by type I or type II/III nodes. If the optimal codebook is determined by type I nodes, the flow diagram 100 may proceed to step 150, where the type I nodes may determine the precoders based on sensing requirements, ISAC codebook (i.e., system codebook), and implicit signaling.

FIG. 4 illustrates an example block diagram 400 for PMI-based precoder design. In particular embodiments, the one or more second signals may comprise one or more implicit signals. In the following, the PMI for the downlink transmission is used as an example to illustrate the embodiments disclosed herein for implicit signaling-based precoder design. In particular embodiments, the first electronic device may receive, from one or more of the second electronic devices, one or more reference-signal reports. As an example and not by way of limitation, at step 410, PMI may be reported from the user equipment and the ISAC system may collect the sensing requirements.

In one embodiment, type II and/or type III Nodes (e.g., communication user equipment) may follow the existing PMI report procedure and send back the index iₚ of the PMI report that leads to the maximum SINR to the gNB, where p=1, 2, . . . , P, and P is the number of available PMI reports. Combined with the obtained sensing requirement (θₘ, Δₙ), the input parameters for determining the sensing and communication precoders may be denoted as (θₘ, Δₙ, iₚ).

Note that because of the quantization of θ and Δ, there may be in total M×N×P possible combinations of (θₘ, Δₙ, iₚ). In particular embodiments, generating the one or more codebooks may comprise generating one or more system codebooks (i.e., ISAC codebooks) based on the one or more sensing requirements and the one or more reference-signal reports. The sensing precoder and the communication precoder may be determined further based on the one or more system codebooks. To determine the sensing and communication precoders for an arbitrary combination of (θₘ, Δₙ, iₚ), in particular embodiments, the ISAC system may maintain the ISAC codebook at type I and/or type II and/or type III nodes to facilitate the determination of precoders. Table 5 illustrates an example ISAC codebook.

TABLE 5
An example ISAC codebook.

| | Sensing requirement | | Sensing requirement |
|---|---|---|---|
| | (θ₁, Δ₁) | . . . | (θ_{M}, Δ_{N}) |
| PMI index i₁ | f_{R}(θ₁, Δ₁, i₁), fc (θ₁, Δ₁, i₁) | . . . | f_{R}(θ_{M}, Δ_{N}, i₁), f_{C}(θ_{M}, Δ_{N}, i₁) |
| . . . | . . . | . . . | . . . |
| PMI index i_{P} | f_{R}(θ₁, Δ₁, i_{P}), fc (θ₁, Δ₁, i_{P}) | . . . | f_{R}(θ_{M}, Δ_{N}, i_{P}), f_{C}(θ_{M}, Δ_{N}, i_{P}) |

In the above example, each entry of the table may include both the sensing precoder f_{R}(θₘ,Δₙ,iₚ) and the communication precoder f_{c}(θₘ, Δₙ, iₚ) for a given combination of (θₘ, Δₙ, iₚ). In another example, the above ISAC codebook may also be maintained using a multi-dimensional matrix.

At step 420, the ISAC system may determine the precoder based on the ISAC codebook. At step 430, the ISAC system may perform signal processing for sensing and communication precoding. At step 440, the ISAC system may perform transmission at transmit antennas.

As described above, a technical advantage of the embodiments may include improved multi-antenna processing for communication and sensing signals based on either explicit or implicit signaling as the signaling may provide useful information for determining optimal precoders for both communication and sensing tasks.

In step 150 in FIG. 1, type II and/or type III nodes may report the PMI report that maximizes the downlink data rate, based on which the type I nodes (e.g., gNBs) may determine the precoders for sensing and communications. However, the type I nodes may not have the exact CSI of the data communication channels, which may prevent it from finding the optimal precoders sensing and communication signals. Referring back to FIG. 1, if the ISAC system determines the optimal codebook is determined by type II/III nodes, the flow diagram 100 may proceed to step 160, wherein type II/III nodes may determine the precoders based on sensing requirements, sensing codebook, and implicit signaling.

In particular embodiments, the ISAC system may determine the optimal precoders for both sensing and communications signals at the type II and/or type III nodes based on the following information. The information may include sensing requirements (θₘ, Δₙ). The sensing requirements may come from any types of nodes. In case the sensing requirements are determined by the type I nodes, those requirements may be quantized by the type I nodes and send to type II/type III nodes via downlink signaling. Such signaling may be not required when the sensing requirements are determined by the type II/type III nodes themselves. The information may also include downlink channel estimation for data communication (e.g., physical data shared channel (PDSCH)). The channel estimation may be obtained based on the transmission of reference signals between the nodes. As an example and not by way of limitation, a gNB acting as a type I node may send the un-beamformed downlink CSI-RS to user equipment (Type II and/or Type III nodes) for the estimation of PDSCH.

With the estimation of the actual downlink channel for data communication, the optimal codebooks for joint sensing and communication may be deterministic. However, since such downlink channel information may be not available at the type I nodes when reusing the existing PMI design, it may be difficult for the type I nodes to determine the optimal precoders for the communication signals, given the interference from the sensing signals. When type II/type III nodes report the best codebook for ISAC system, the technical challenge of determining optimal precoders via implicit signals may be solved by estimating channel information about the actual channel as the channel estimation may capture the potential interference between sensing and communication signals, which enables determining the actual achievable data rate for a particular pair of sensing and communication precoders.

In particular embodiments, after obtaining the sensing requirements and downlink channel estimation, the type II and/or type III nodes may search the ISAC codebook to find the optimal precoders that achieve the maximum objectives. Note that, the ISAC codebooks may or may not be different from the existing PMI report that is designed for communication only. In alternative embodiments, the best precoders may be those that achieve the highest downlink data rate while satisfying the sensing requirements.

After determining the optimal precoder from the ISAC codebook, the type II and/or type III nodes may report the indices of the optimal precoder back to the type I nodes. The type I nodes may use the reported precoders to perform sensing and communication.

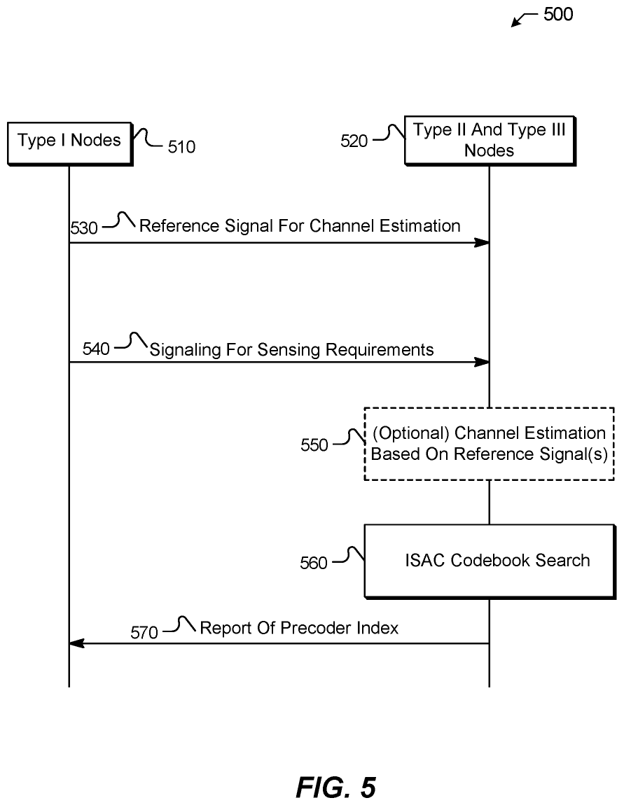

FIG. 5 illustrates an example sequence diagram 500 for a scenario where a device acts as both type II and type III nodes. At step 530, type I nodes 510 may send one or more reference signals to the type II/III node 520 for channel estimation. At step 540, type I nodes 510 may send signaling for sensing requirements. In particular embodiments, the device (type II/III node 510) may be capable of estimating the propagation channels of both sensing and communication signals. In other words, the type II/III node 510 may perform channel estimation at step 550, which may be optional. When the device is informed about the sensing requirements, e.g., based on the signaling from type I nodes, it may search the ISAC codebook to find the optimal precoder for joint sensing and communication at step 560. In particular embodiments, multiple criteria may be used for the codebook search. In one embodiment, the best matching codebook may be the index of the highest SINR under given radar distortion. In another embodiment, the best matching codebook may be the index of the smallest radar distortion for given/target SINR. Other methods/criteria for selecting the best codebook may be supported. Then, at step 570, the type II/III node 520 may report the index of the optimal precoder back to the type I nodes 510. In other words, the first electronic device may transmit, from the first electronic device to one or more of the second devices, information associated with the sensing precoder and the communication precoder.

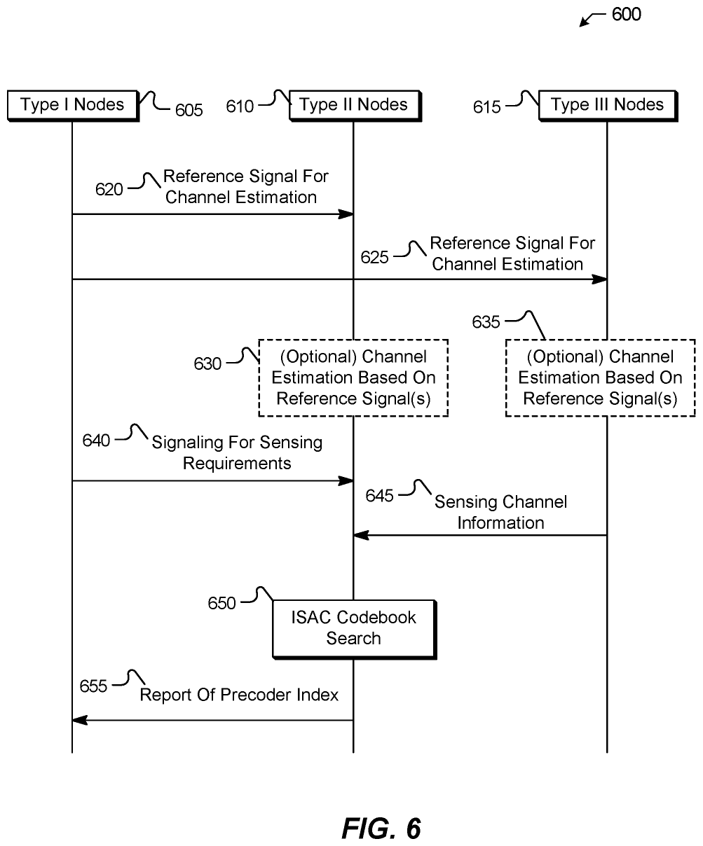

FIG. 6 illustrates an example sequence diagram 600 for a scenario where type II and type III nodes are different devices. At step 620, type I nodes 605 may send one or more reference signals to the type II node 610 for channel estimation. At step 625, type I nodes 605 may send one or more reference signals to the type III node 615 for channel estimation. At step 630, the type II node 610 may perform channel estimation based on the reference signals, which may be optional. At step 635, the type III node 615 may perform channel estimation based on the reference signals, which may be optional. At step 640, type I nodes 605 may send signaling for sensing requirements to type II node 610. In particular embodiments, the device acting as type III node 615 may send directly or indirectly the information related to the propagation channels of sensing signals to type II node 610 to help the type II node to find the optimal precoder for joint sensing and communication at step 645. In one embodiment of direct informing by the type III node 615 to the type II node 610 may include the scenario where the type II and type III nodes are two different network side devices such as gNB and the backhaul link may be used for sending the information related to the propagation channels of sensing signal. In one embodiment of indirect informing by the type III node 615 to the type II node 610 may include the scenario where the type II and type III nodes are two different user equipment/devices and the devices may send the information related to the propagation channels of sensing signal to network side first and the network side then informs the user equipment side. At step 650, type II node 610 may select the best precoder based on ISAC codebook search. At step 655, type II node 610 may report back the index to the type I nodes. In other words, the first electronic device may transmit, from the first electronic device to one or more of the second devices, information associated with the sensing precoder and the communication precoder.

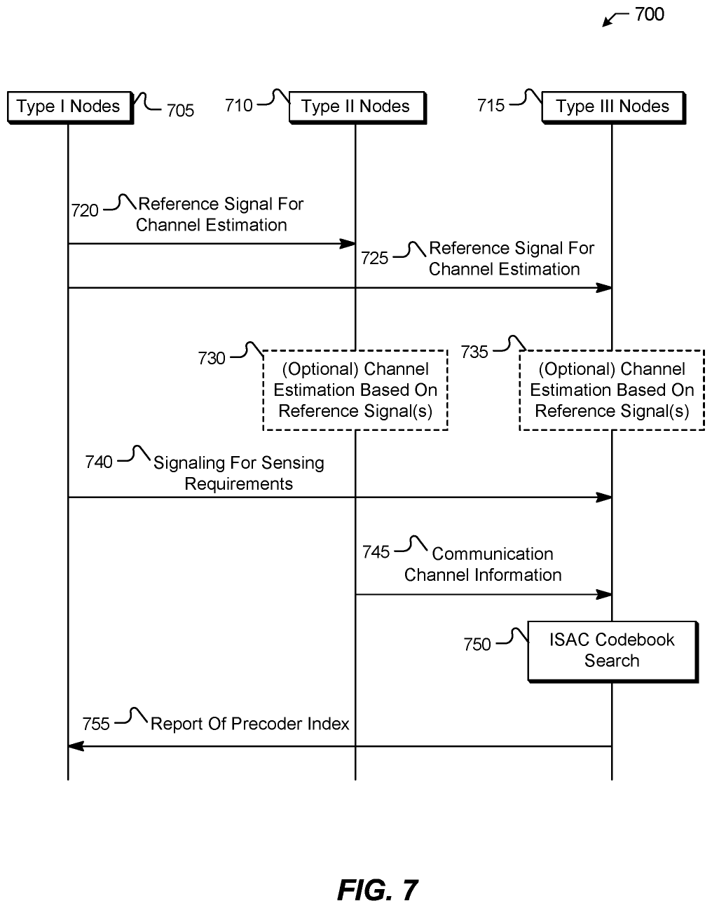

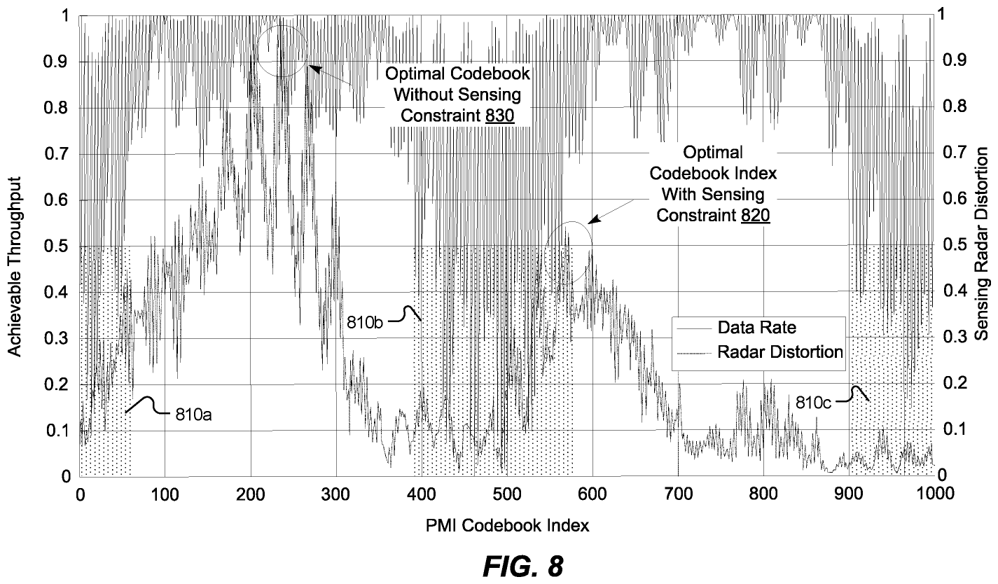

FIG. 7 illustrates an example sequence diagram 700 for a scenario where type III nodes report the optimal precoder for joint sensing and communication. In particular embodiments, the sensing requirements may be known by the type III nodes. In case the sensing requirements are originated from type I nodes, these requirements may be communicated with the type III nodes via signaling. Moreover, the devices acting as type II nodes may send the information (either explicitly or implicitly) related to the communication channels to the type III nodes. Then, the devices acting as type III nodes may look up the ISAC codebook and report the index of the optimal precoder for joint sensing and communication.

At step 720, type I nodes 705 may send one or more reference signals to the type II node 710 for channel estimation. At step 725, type I nodes 705 may send one or more reference signals to the type III node 715 for channel estimation. At step 730, the type II node 710 may perform channel estimation based on the reference signals, which may be optional. At step 735, the type III node 715 may perform channel estimation based on the reference signals, which may be optional. At step 740, type I nodes 705 may send signaling for sensing requirements to type III node 715. At step 745, the type II node 710 may send communication channel information to type III node 715. At step 750, the type III node 715 may perform ISAC codebook search to determine the optimal precoder. At step 755, the type III node 715 may select the best precoder and report back the index to the type I nodes 705. In other words, the first electronic device may transmit, from the first electronic device to one or more of the second devices, information associated with the sensing precoder and the communication precoder.

The performance of the embodiments disclosed herein was evaluated and validated based on a plurality of simulations. The simulation platform was a 3GPP NR Release 16 system-level simulator (SLS). This SLS can accurately model the practical MU-MIMO systems. Therefore, the results obtained from the SLS can effectively reflect the performance of the embodiments disclosed herein when deployed in practice.

A first simulation was conducted to demonstrate the necessity of communicating sensing requirement by investigating the throughput and radar waveform distortion that can be achieved by using the 3GPP Release 16 reports. For each of the precoder in the report, the achievable downlink data rate as well as the achievable radar distortion at a particular communication user equipment (e.g., type II nodes) and a given sensing direction θ=288o were determined. It was observed from this simulation that, the achievable data rate and the radar distortion were in general uncorrelated across all the reports. That is, for a certain report, while it may achieve a relatively high data rate, the sensing performance of using this report may suffer due to its high radar waveform distortion. It was also observed from this simulation that reusing the existing 3GPP Release 16 reports for ISAC systems may be inappropriate since the user equipment (which could be type II and/or type III nodes) may only report the indices of the PMI reports that lead to the maximum data rate, while the same report may not be able to satisfy the sensing requirement. In this simulation, the report with index 236 was reported by the user equipment as it achieved the maximum throughput. However, using this particular report led to a high radar distortion, i.e., 0.93, which may lead to a relatively poor sensing performance as the measurements collected under a higher radar distortion could be inaccurate.

Hence, it may be necessary for the network devices (type I/II/III nodes) to communicate the sensing requirement, e.g., maximum radar distortion, in the ISAC systems such that the report can be chosen properly to serve both the purposes of communication and sensing. Consider that the requirement on the radar distortion Δ is Δ≤0.5. When the communication user equipment (type II nodes) is aware of this requirement, the optimal precoder for both sensing and communication may be determined as the precoder that achieves the maximum throughput among those who can also provide a radar distortion that is less than or equal to 0.5. FIG. 8 illustrates example best codebooks for communication only and joint sensing and communication, respectively. As shown in FIG. 8, only the codebooks within the boxes 810 may be feasible considering the sensing requirement of Δ≤0.5. Now, with the embodiments disclosed herein, the communication user equipment may report the codebook with index 564 instead (e.g., optimal codebook index with sensing constraint 820), as it achieved the maximum throughput (rate=0.488) with a satisfactory sensing performance (distortion Δ=0.497). By contrast, optimal codebook without sensing constraint 830 may not have a good sensing performance.

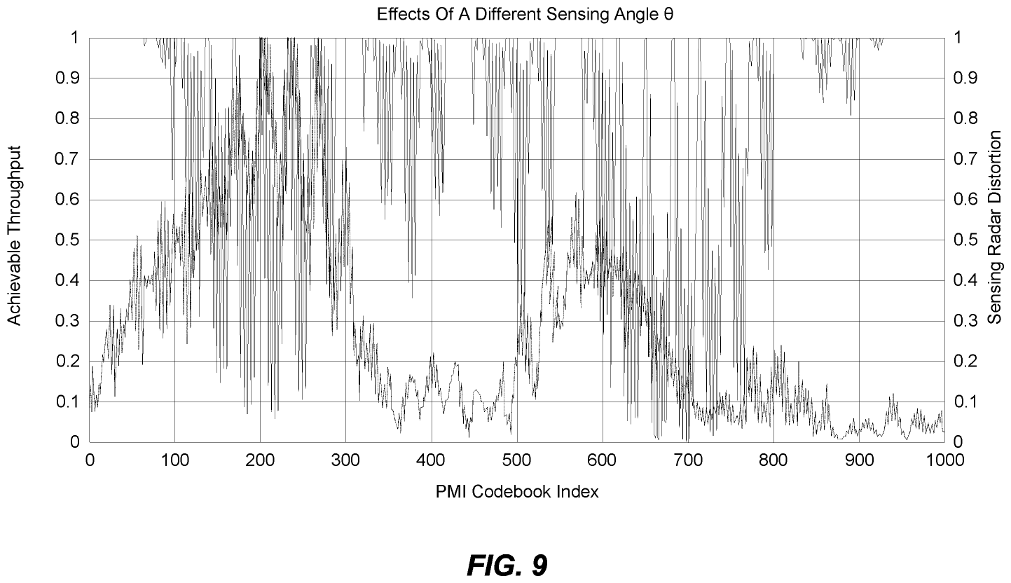

In a second simulation, change the value of sensing angle θ was changed from 0=288o to θ=36o and the data rate and radar distortion for the same communication user equipment were evaluated. FIG. 9 illustrates example effects of using a different sensing angle on the radar distortion and achievable throughput. It was observed that while the achievable data rate was the same as the first simulation, the radar distortion under a different θ differed significantly from the results of the first simulation. With a different θ, the same set of codebooks at the user equipment experienced a significantly different patterns in the achievable radar distortion. These results may verify the necessity of the ISAC codebook disclosed in the present disclosure, where a codebook may be specifically designed for a given pair of sensing requirements, e.g., (θ, Δ).

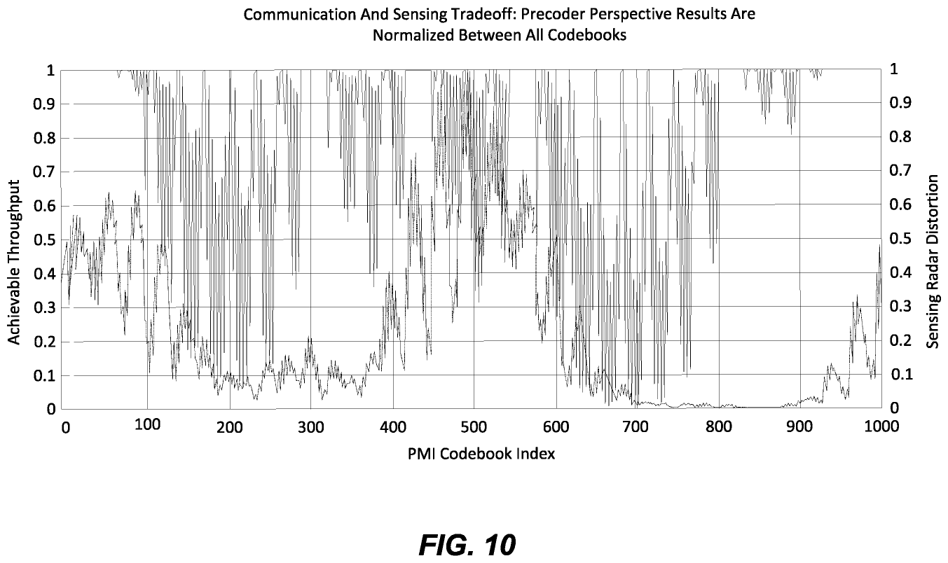

A third simulation showed the throughput and radar distortion experienced by a different communication user equipment, with the same sensing requirements using the same set of codebooks. FIG. 10 illustrates an example radar distortion and achievable throughput experienced by another user equipment with the same sensing angle. It was observed that for a different communication user equipment, while the achievable throughput of the codebooks was significantly different from those experienced by the previously examined communication user equipment, the radar distortion still remained unchanged. This may be because: (a) for data communication, different user equipment may experience different downlink channels, which may change the achievable throughput of the codebooks at different communication user equipment, and (b) for the monostatic sensing scenario implemented in the simulation, the radar distortion may only depend on the value of θ, which may remain unchanged for two different communication user equipment. The third simulation showed that, even for the same sensing requirement, the optimal codebook for joint sensing and communication for different communication user equipment may be different since they may experience different downlink channels. Using the simulations disclosed herein as examples, under the same sensing requirement, the indices of the optimal codebook for the first communication user equipment was 564, while that of the second communication user equipment was 501. Therefore, it may be necessary to allow each user equipment to report its optimal codebook for ISAC based on both the estimation of downlink channel and the sensing requirements, which may be communicated to the user equipment via signaling.

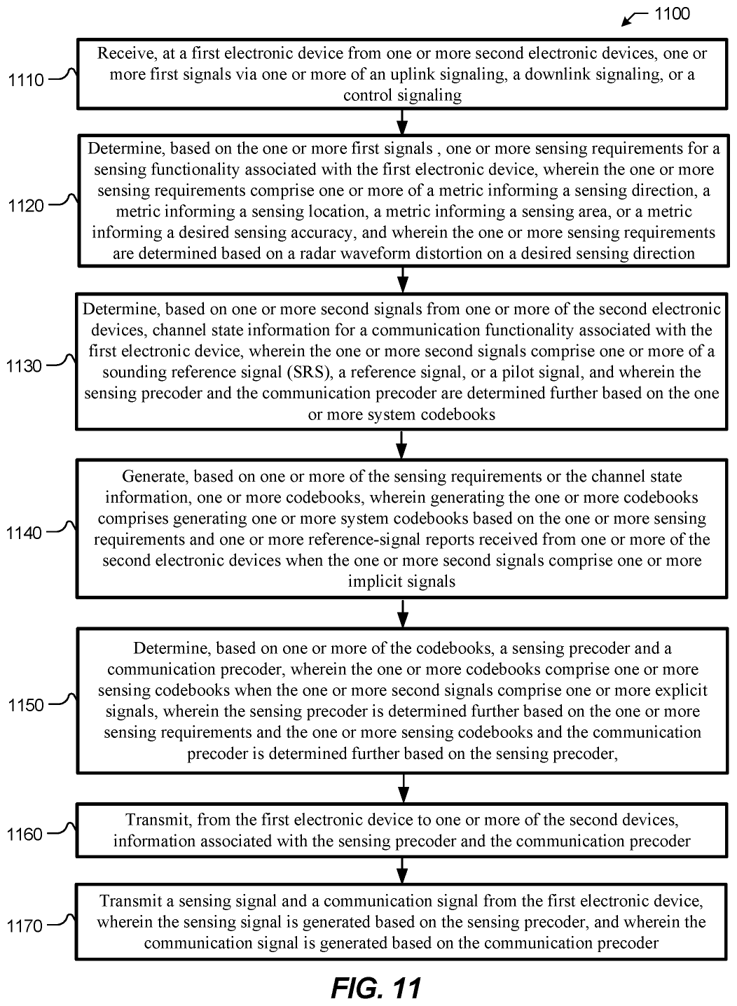

FIG. 11 illustrates is a flow diagram of a method 1100 for determining sensing and communication precoders, in accordance with the presently disclosed embodiments. The method 1100 may be performed utilizing one or more processing devices (e.g., a first electronic device) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing wireless communication data, software (e.g., instructions running/executing on one or more processors), firmware (e.g., microcode), or some combination thereof.

The method 1100 may begin at step 1110 with the one or more processing devices (e.g., the first electronic device). For example, in particular embodiments, the first electronic device may receive, at the first electronic device from one or more second electronic devices, one or more first signals via one or more of an uplink signaling, a downlink signaling, or a control signaling. The method 1100 may then continue at step 1120 with the one or more processing devices (e.g., the first electronic device). For example, in particular embodiments, the first electronic device may determine, based on the one or more first signals, one or more sensing requirements for a sensing functionality associated with the first electronic device, wherein the one or more sensing requirements comprise one or more of a metric informing a sensing direction, a metric informing a sensing location, a metric informing a sensing area, or a metric informing a desired sensing accuracy, and wherein the one or more sensing requirements are determined based on a radar waveform distortion on a desired sensing direction. The method 1100 may then continue at step 1130 with the one or more processing devices (e.g., the first electronic device). For example, in particular embodiments, the first electronic device may determine, based on one or more second signals from one or more of the second electronic devices, channel state information for a communication functionality associated with the first electronic device, wherein the one or more second signals comprise one or more of a sounding reference signal (SRS), a reference signal, or a pilot signal, and wherein the sensing precoder and the communication precoder are determined further based on the one or more system codebooks. The method 1100 may then continue at step 1140 with the one or more processing devices (e.g., the first electronic device). For example, in particular embodiments, the first electronic device may generate, based on one or more of the sensing requirements or the channel state information, one or more codebooks, wherein generating the one or more codebooks comprises generating one or more system codebooks based on the one or more sensing requirements and one or more reference-signal reports received from one or more of the second electronic devices when the one or more second signals comprise one or more implicit signals. The method 1100 may then continue at step 1150 with the one or more processing devices (e.g., the first electronic device). For example, in particular embodiments, the first electronic device may determine, based on one or more of the codebooks, a sensing precoder and a communication precoder, wherein the one or more codebooks comprise one or more sensing codebooks when the one or more second signals comprise one or more explicit signals, wherein the sensing precoder is determined further based on the one or more sensing requirements and the one or more sensing codebooks and the communication precoder is determined further based on the sensing precoder. The method 1100 may then continue at step 1160 with the one or more processing devices (e.g., the first electronic device). For example, in particular embodiments, the first electronic device may transmit, from the first electronic device to one or more of the second devices, information associated with the sensing precoder and the communication precoder. The method 1100 may then continue at step 1170 with the one or more processing devices (e.g., the first electronic device). For example, in particular embodiments, the first electronic device may transmit a sensing signal and a communication signal from the first electronic device, wherein the sensing signal is generated based on the sensing precoder, and wherein the communication signal is generated based on the communication precoder. Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for determining sensing and communication precoders including the particular steps of the method of FIG. 11, this disclosure contemplates any suitable method for determining sensing and communication precoders including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

### Systems and Methods

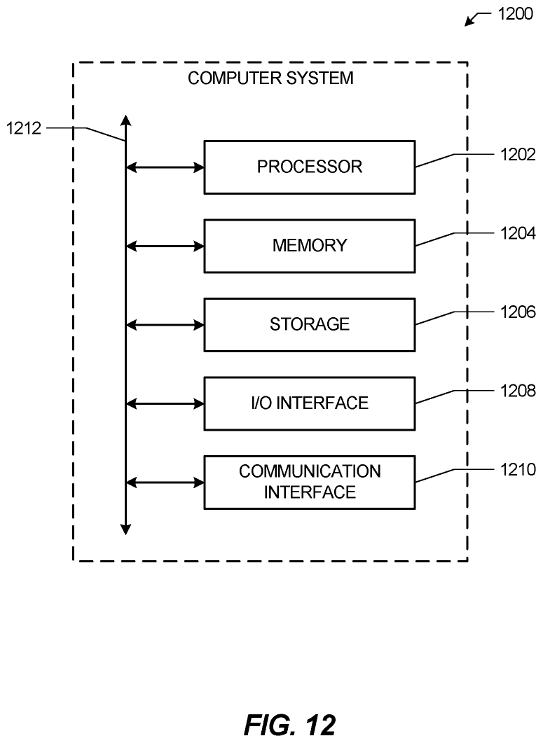

FIG. 12 illustrates an example computer system 1200 that may be utilized for determining sensing and communication precoders, in accordance with the presently disclosed embodiments. In particular embodiments, one or more computer systems 1200 perform one or more steps of one or more methods described or illustrated herein. In particular embodiments, one or more computer systems 1200 provide functionality described or illustrated herein. In particular embodiments, software running on one or more computer systems 1200 performs one or more steps of one or more methods described or illustrated herein or provides functionality described or illustrated herein. Particular embodiments include one or more portions of one or more computer systems 1200. Herein, reference to a computer system may encompass a computing device, and vice versa, where appropriate. Moreover, reference to a computer system may encompass one or more computer systems, where appropriate.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks.

Where appropriate, one or more computer systems 1200 may perform without substantial spatial or temporal limitation one or more steps of one or more methods described or illustrated herein. As an example, and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In particular embodiments, computer system 1200 includes a processor 1202, memory 1204, storage 1206, an input/output (I/O) interface 1208, a communication interface 1210, and a bus 1212. Although this disclosure describes and illustrates a particular computer system having a particular number of particular components in a particular arrangement, this disclosure contemplates any suitable computer system having any suitable number of any suitable components in any suitable arrangement. In particular embodiments, processor 1202 includes hardware for executing instructions, such as those making up a computer program. As an example, and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example, and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202.

Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In particular embodiments, memory 1204 includes main memory for storing instructions for processor 1202 to execute or data for processor 1202 to operate on. As an example, and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere).

One or more memory buses (which may each include an address bus and a data bus) may couple processor 1202 to memory 1204. Bus 1212 may include one or more memory buses, as described below. In particular embodiments, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memory devices, where appropriate. Although this disclosure describes and illustrates particular memory, this disclosure contemplates any suitable memory.

In particular embodiments, storage 1206 includes mass storage for data or instructions. As an example, and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In particular embodiments, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In particular embodiments, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In particular embodiments, communication interface 1210 includes hardware, software, or both providing one or more interfaces for communication (such as, for example, packet-based communication) between computer system 1200 and one or more other computer systems 1200 or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it.

As an example, and not by way of limitation, computer system 1200 may communicate with an ad hoc network, a personal area network (PAN), a local area network (LAN), a wide area network (WAN), a metropolitan area network (MAN), an ultra-wideband network (UWB), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example, and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a first electronic device:
determining, based on one or more first signals from one or more second electronic devices, one or more sensing requirements for a sensing functionality associated with the first electronic device;
determining, based on one or more second signals from one or more of the second electronic devices, channel state information for a communication functionality associated with the first electronic device;
generating, based on one or more of the sensing requirements or the channel state information, one or more codebooks;
determining, based on one or more of the codebooks, a sensing precoder and a communication precoder; and
transmitting a sensing signal and a communication signal from the first electronic device, wherein the sensing signal is generated based on the sensing precoder, and wherein the communication signal is generated based on the communication precoder.

2. The method of claim 1, further comprising:
receiving, at the first electronic device from the one or more second electronic devices, the one or more first signals via one or more of an uplink signaling, a downlink signaling, or a control signaling.

3. The method of claim 1, wherein the one or more sensing requirements comprise one or more of a metric informing a sensing direction, a metric informing a sensing location, a metric informing a sensing area, or a metric informing a desired sensing accuracy.

4. The method of claim 1, wherein the one or more sensing requirements are determined based on a radar waveform distortion on a desired sensing direction.

5. The method of claim 1, wherein the one or more second signals comprise one or more of a sounding reference signal (SRS), a reference signal, or a pilot signal.

6. The method of claim 1, wherein the one or more second signals comprise one or more explicit signals, wherein the one or more codebooks comprise one or more sensing codebooks, wherein the sensing precoder is determined further based on the one or more sensing requirements and the one or more sensing codebooks, and wherein the communication precoder is determined further based on the sensing precoder.

7. The method of claim 1, wherein the one or more second signals comprise one or more implicit signals, wherein the method further comprises:
receiving, from one or more of the second electronic devices, one or more reference-signal reports;
wherein generating the one or more codebooks comprises generating one or more system codebooks based on the one or more sensing requirements and the one or more reference-signal reports, and
wherein the sensing precoder and the communication precoder are determined further based on the one or more system codebooks.

8. The method of claim 1, further comprising:
transmitting, from the first electronic device to one or more of the second devices, information associated with the sensing precoder and the communication precoder.

9. A first electronic device comprising:
one or more non-transitory computer-readable storage media including instructions; and
one or more processors coupled to the storage media, the one or more processors configured to execute the instructions to:
determine, based on one or more first signals from one or more second electronic devices, one or more sensing requirements for a sensing functionality associated with the first electronic device;
determine, based on one or more second signals from one or more of the second electronic devices, channel state information for a communication functionality associated with the first electronic device;
generate, based on one or more of the sensing requirements or the channel state information, one or more codebooks;
determine, based on one or more of the codebooks, a sensing precoder and a communication precoder; and
transmit a sensing signal and a communication signal from the first electronic device, wherein the sensing signal is generated based on the sensing precoder, and wherein the communication signal is generated based on the communication precoder.

10. The electronic device of claim 9, wherein the one or more processors are further configured to execute the instructions to:
receive, at the first electronic device from the one or more second electronic devices, the one or more first signals via one or more of an uplink signaling, a downlink signaling, or a control signaling.

11. The electronic device of claim 9, wherein the one or more sensing requirements comprise one or more of a metric informing a sensing direction, a metric informing a sensing location, a metric informing a sensing area, or a metric informing a desired sensing accuracy.

12. The electronic device of claim 9, wherein the one or more sensing requirements are determined based on a radar waveform distortion on a desired sensing direction.

13. The electronic device of claim 9, wherein the one or more second signals comprise one or more of a sounding reference signal (SRS), a reference signal, or a pilot signal.

14. The electronic device of claim 9, wherein the one or more second signals comprise one or more explicit signals, wherein the one or more codebooks comprise one or more sensing codebooks, wherein the sensing precoder is determined further based on the one or more sensing requirements and the one or more sensing codebooks, and wherein the communication precoder is determined further based on the sensing precoder.

15. The electronic device of claim 9, wherein the one or more second signals comprise one or more implicit signals, wherein the one or more processors are further configured to execute the instructions to:
receive, from one or more of the second electronic devices, one or more reference-signal reports;
wherein generating the one or more codebooks comprises generating one or more system codebooks based on the one or more sensing requirements and the one or more reference-signal reports, and
wherein the sensing precoder and the communication precoder are determined further based on the one or more system codebooks.

16. A computer-readable non-transitory storage media comprising instructions executable by a processor to:
determine, by a first electronic device based on one or more first signals from one or more second electronic devices, one or more sensing requirements for a sensing functionality associated with the first electronic device;
determine, by the first electronic device based on one or more second signals from one or more of the second electronic devices, channel state information for a communication functionality associated with the first electronic device;
generate, by the first electronic device based on one or more of the sensing requirements or the channel state information, one or more codebooks;
determine, by the first electronic device based on one or more of the codebooks, a sensing precoder and a communication precoder; and
transmit a sensing signal and a communication signal from the first electronic device, wherein the sensing signal is generated based on the sensing precoder, and wherein the communication signal is generated based on the communication precoder.

17. The media of claim 16, further comprising instructions executable by the processor to:
receive, at the first electronic device from the one or more second electronic devices, the one or more first signals via one or more of an uplink signaling, a downlink signaling, or a control signaling.

18. The media of claim 16, wherein the one or more sensing requirements comprise one or more of a metric informing a sensing direction, a metric informing a sensing location, a metric informing a sensing area, or a metric informing a desired sensing accuracy.

19. The media of claim 16, wherein the one or more sensing requirements are determined based on a radar waveform distortion on a desired sensing direction.

20. The media of claim 16, wherein the one or more second signals comprise one or more of a sounding reference signal (SRS), a reference signal, or a pilot signal.
